(19) United States
(12) Patent Application Publication
(10) Pub. No.: US 2019/0126699 A1
(43) Pub. Date: May 2, 2019

(54) TRAILER HITCH ATTACHMENT

(71) Applicant: Jason Cory, Bricelyn, MN (US)

(72) Inventor: Jason Cory, Bricelyn, MN (US)

(21) Appl. No.: 16/148,023

(22) Filed: Oct. 1, 2018

Related U.S. Application Data
(60) Provisional application No. 62/578,017, filed on Oct. 27, 2017.

(51) Int. Cl. B60D 1/52; B60D 1/06; E02F 3/96

(52) U.S. Cl. CPC B60D 1/52; B60D 2001/001; E02F 3/962; B60D 1/06

(57) ABSTRACT

The present invention provides a trailer hitch attachment for a front end loader. The trailer hitch attachment comprises a frame having a first frame member perpendicularly affixed to a second frame member. The first frame member includes a channel configured to slidably receive a first end of an elongated member. The first frame member and the first end of the elongated each include an aperture that receives a fastener to secure the first end of the elongated member within the channel. A second end of the elongated member further comprises a universal ball mount having a plurality of ball hitches thereon. The second frame member is affixed to a panel that removably secures to a surface of a front end loader via a fastener. In an alternative embodiment, the frame further includes a pair of support members that are diagonally disposed between the first and second frame member.

### CROSS REFERENCE TO RELATED APPLICATION

This application claims the benefit of U.S. Provisional Application No. 62/578,017 filed on Oct. 27, 2017. The above identified patent application is herein incorporated by reference in its entirety to provide continuity of disclosure.

### BACKGROUND OF THE INVENTION

The present invention relates to trailer hitches. More specifically, the present invention provides a trailer hitch attachment for a front end loader. In a preferred embodiment, the trailer hitch attachment secures to a surface of a bucket of the front end loader, thereby allowing a user to maneuver a trailer secured to the hitch.

In many instances, trailer hitches are typically attached to a rear of a vehicle. Because of this, when positioning a trailer, individuals often feel strain in their neck due to having to look over their shoulder while maneuvering. It is also a possibility that an individual may accidentally back a trailer into an object or other individual due to poor visibility. Manually maneuvering the trailer can lead to back injuries. It often requires more than one person to move a trailer into position otherwise individuals find themselves in hazardous conditions attempting to do it alone. Therefore, a trailer hitch attachment that can be readily secured to a front end loader to allow for easy maneuvering of a trailer while providing increased visibility is needed.

Devices have been disclosed in the known art that relate to trailer hitches. These include devices that have been patented and published in patent application publications. These devices generally relate to trailer hitch for rear ends of various vehicles. Some devices disclose quick connect attachments for use on platforms, forklifts, and cranes for supporting various loads. Other devices disclosed adjustable hitch assemblies that attached to vehicle frames. These known art devices have several known drawbacks. These devices fail to include a unitary frame that removably secures to a bucket of a front end loader. Further these devices fail to include diagonally disposed support members that provide structural support to the hitch attachment.

In light of the devices disclosed in the known art, it is submitted that the present invention substantially diverges in design elements from the known art and consequently it is clear that there is a need in the art for an improvement to existing trailer hitch devices. In this regard the instant invention substantially fulfills these needs.

### SUMMARY OF THE INVENTION

In view of the foregoing disadvantages inherent in the known types of trailer hitches now present in the known art, the present invention provides a new trailer hitch attachment wherein the same can be utilized for providing convenience for the user when maneuvering a trailer with a front end loader.

It is therefore an object of the present invention to provide a new and improved trailer hitch attachment that has all of the advantages of the known art and none of the disadvantages.

It is another object of the present invention to provide a trailer hitch attachment comprising a frame having a first frame member perpendicularly affixed to a second frame member. The first frame member includes a channel configured to slidably receive a first end of an elongated member. The first frame member and the first end of the elongated member each include an aperture that receives a fastener to secure the first end of the elongated member within the channel. A second end of the elongated member further comprises a universal ball mount having a plurality of ball hitches thereon. The second frame member is affixed to a panel that removably secures to a surface of a front end loader via a fastener. In an alternative embodiment, the frame further includes a pair of support members that are diagonally disposed between the first and second frame member.

Another object of the present invention is to provide a trailer hitch attachment that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the trailer hitch attachment.

FIG. 2 shows a top view of an embodiment of the trailer hitch attachment.

FIG. 3 shows an exploded view of an embodiment of the trailer hitch attachment, wherein the panel of the frame is secured to a bucket of a front end loader.

FIG. 4 shows a side perspective view of an embodiment of the trailer hitch attachment, wherein the ball hitch is secured to a trailer.

### DETAILED DESCRIPTION OF THE INVENTION

Reference is made herein to the attached drawings. Like reference numerals are used throughout the drawings to depict like or similar elements of the trailer hitch attachment for a front end loader. For the purposes of presenting a brief and clear description of the present invention, the preferred embodiment will be discussed as used for maneuvering a trailer with a front end loader. The figures are intended for representative purposes only and should not be considered to be limiting in any respect.

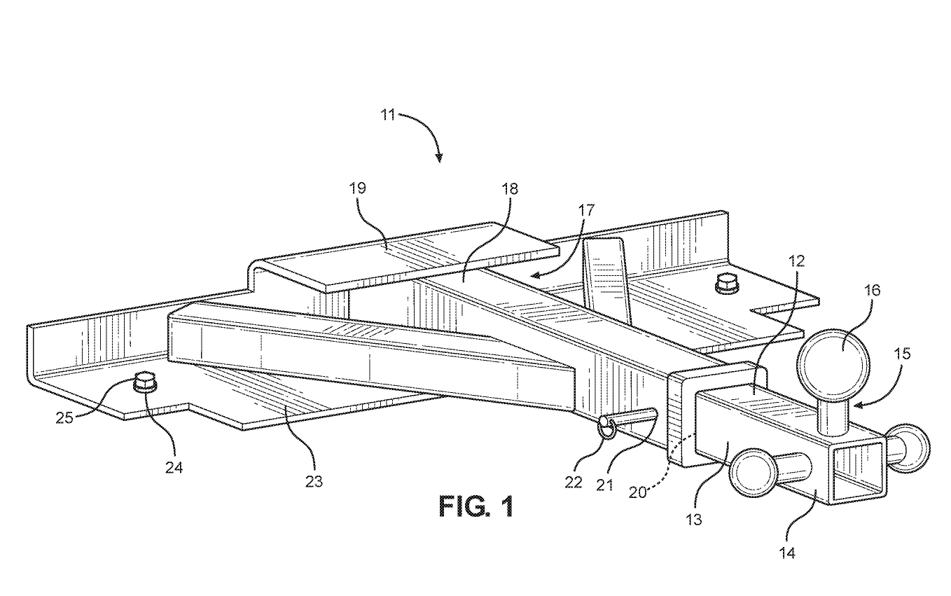

Referring now to FIG. 1, there is shown a perspective view of an embodiment of the trailer hitch attachment. The trailer hitch attachment 11 comprises an elongated member 12 having a first end 13 and a second end 14, wherein the first end 13 includes an aperture along each side thereof, and the second end 14 includes a universal ball mount 15 having a plurality of ball hitches 16 affixed thereto. The trailer hitch attachment further includes a frame 17 comprising a first frame member 18 perpendicularly affixed to a second frame member 19, wherein the first frame member 18 includes a channel 20 configured to slidably receive the first end 13 of the elongated member 12.

The first frame member 18 includes a pair of openings 21 disposed on opposing sides of the channel 20, wherein the pair of openings 21 are configured to align with the aperture on each side of the first end 13 of elongated member 12, such that each of the pair of openings 21 and the aperture of each side of the first end 13 are adapted to receive a fastener 22 therethrough. In the illustrated embodiment, the fastener 22 is steel pin, wherein the pin is used to removably secure the first end 13 of the elongated member 12 within the channel 20. However, any suitable fastener may be used.

The second frame member 19 is affixed to a panel 23 having a plurality of apertures 24 thereon, wherein the plurality of apertures 24 are configured to receive a plurality of fasteners 25 therethrough. In this way, the panel 23 is configured to removably secure to a bucket of a front end loader via the plurality of apertures 24 and a plurality of fasteners 25. In the illustrated embodiment, the plurality of fasteners 25 are bolts. However, any suitable fastener may be used.

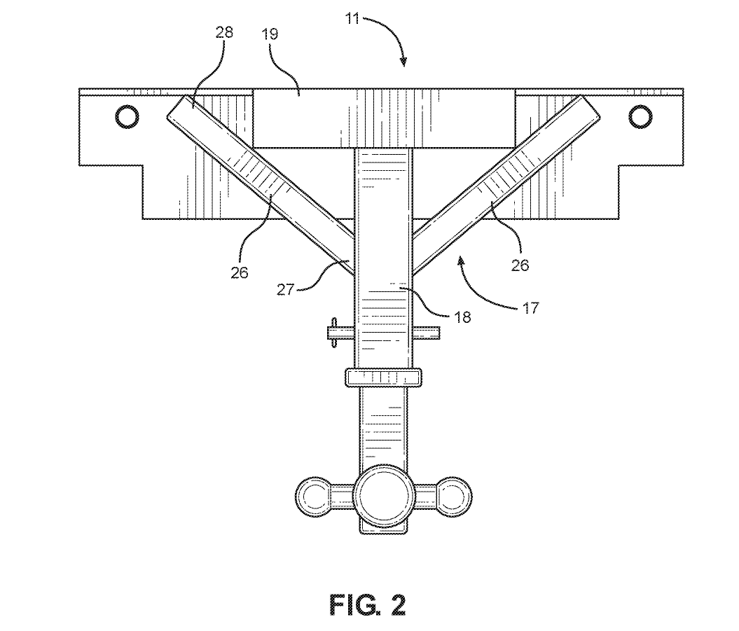

Referring now to FIG. 2, there is shown a top view of an embodiment of the trailer hitch attachment. In the illustrated embodiment, the frame 17 of the trailer hitch attachment 11 further comprises a pair of support members 26 that are diagonally disposed between the first frame member 18 and the second frame member 19. A first end 27 of each of the pair of support members 26 is affixed to the first frame member 18 and a second end 28 of each of the pair of support members 26 is affixed to the second frame member 19. Each support member 26 is configured to provide structural support to the trailer hitch attachment 11 when secured to the front end loader. In this way, the support members 26 allow the trailer hitch attachment 11 to support and maneuver trailers of substantial weight without sustaining any structural failure to the hitch 11.

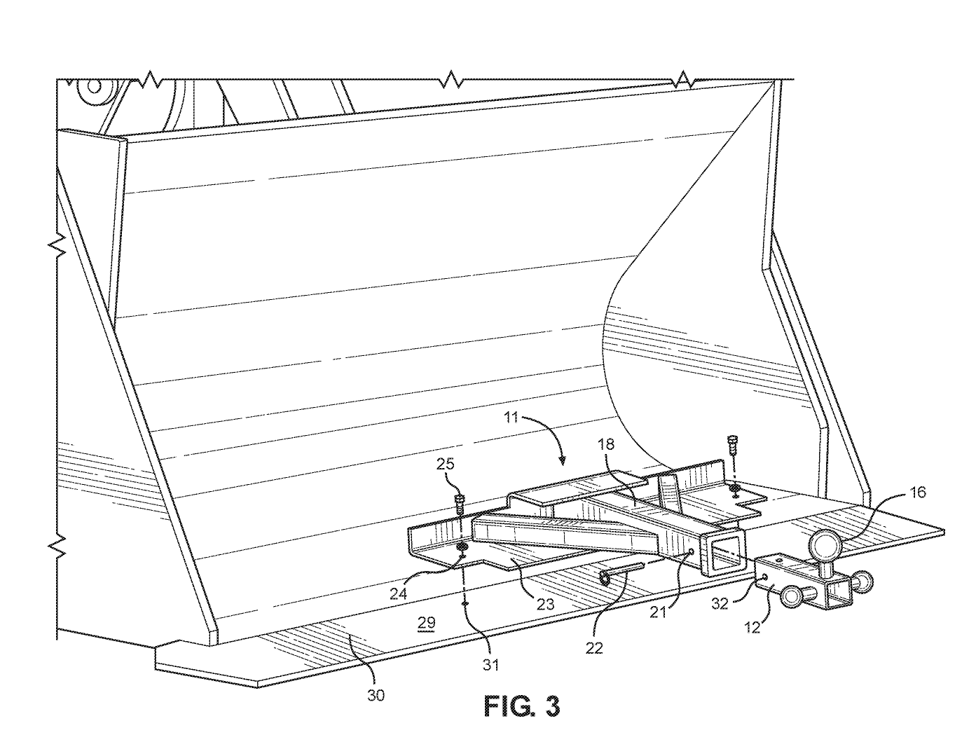

Referring now to FIG. 3, there is shown an exploded view of an embodiment of the trailer hitch, wherein the panel of the frame secures to a bucket of a front end loader. In the illustrated embodiment, the trailer hitch attachment 11 removably secures to a surface 29 of a bucket 30 of a front end loader. The surface 29 of the bucket 30 includes a plurality of apertures 31 disposed therethrough. The plurality of apertures 24 of the panel 23 are configured to align with the plurality of apertures 31 on the surface 29 of the bucket 30, wherein a plurality of fasteners 25 are received therethrough, such that the trailer hitch attachment 11 is removably secured to the front end loader.

Once the trailer hitch attachment 11 is secured to the bucket 30, the elongated member 12 may be slidably removed from the frame 17 simply by removing the fastener 22 from the pair of apertures 21 of first frame member 18. In the illustrated embodiment, the fastener 22 is steel pin, wherein the pin is used to removably secure the first end 13 of the elongated member 12 within the channel 20. However, any suitable fastener may be used. In this way, the elongated member 12 can be removed, rotated, and reattached within the frame 17, such that a desired size ball hitch of the plurality of ball hitches 16 may be used.

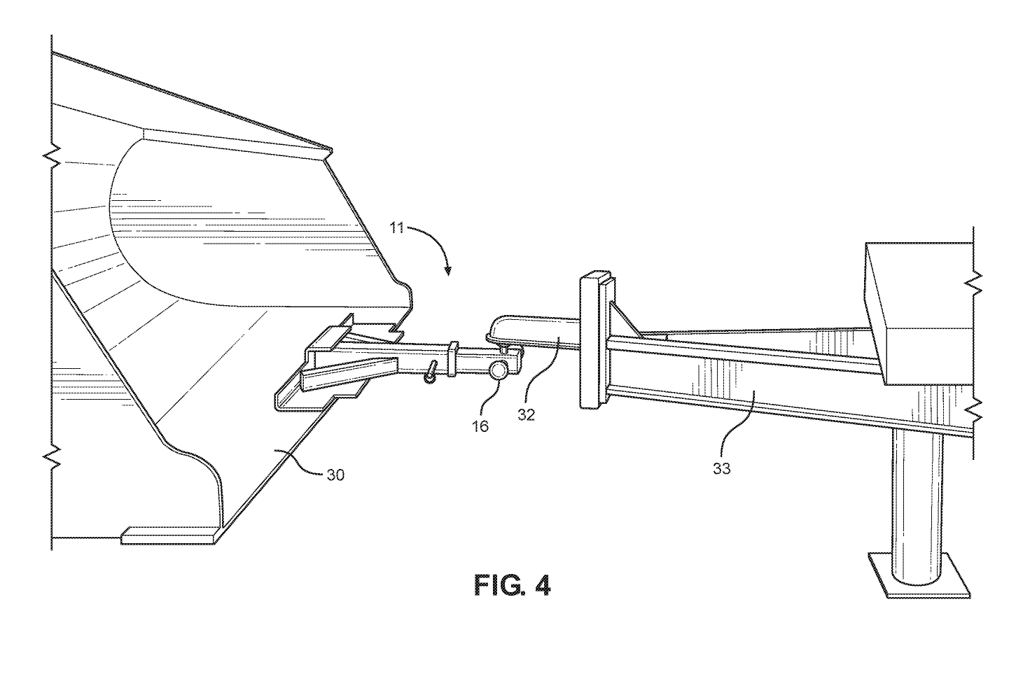

Referring now to FIG. 4, there is shown a side perspective view of an embodiment of the trailer hitch attachment, wherein the ball hitch is secured to a trailer. The trailer hitch attachment 11 is configured to secure to the bucket 30 of a front end loader. Once secured, a ball hitch of the plurality of ball hitches 16 is received with an opening on an arm 32 of a trailer 33. Once the trailer 33 is secured to the trailer hitch attachment 11, a user can maneuver the trailer 33 by utilizing the front end loader. Using the trailer hitch attachment 11 in conjunction with a front end loader provides the user with better visibility and prevents neck strain that can be caused by using a traditional trailer hitch that is secured to a rear end of a vehicle.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trailer hitch attachment, comprising:
an elongated member having a first end and a second end, wherein the first end includes an aperture along each side thereof, and the second end includes a universal ball mount having a plurality of ball hitches thereon;
a frame comprising a first frame member perpendicularly affixed to a second frame member, wherein the first frame member includes a channel configured to slidably receive the first end of the elongated member;
wherein the first frame member includes a pair of openings disposed on opposing sides of the channel, wherein each of the pair of openings are configured to align with the aperture on each side of the elongated member, such that pair of openings and the aperture on each side of the elongated member are adapted to receive a fastener therethrough;
wherein the second frame member is affixed to a panel having a plurality of apertures, wherein the plurality of apertures are configured to receive a plurality of fasteners, such that the panel is removably securable to a surface of a bucket of a front end loader.

2) The trailer hitch attachment of claim 1, further comprising a pair of support members that are diagonally disposed between the first frame member and the second frame member, such that a first end of each of the pair of support members is affixed to the first frame member and a second end of each of the pair of support members is affixed to the second frame member.

3) The trailer hitch attachment of claim 1, wherein the fastener is a steel pin.

4) The trailer hitch attachment of claim 1, wherein the plurality of fasteners are bolts.

5) The trailer hitch attachment of claim 1, wherein the trailer hitch attachment is constructed of a durable material.

6) The trailer hitch attachment of claim 1, wherein the trailer hitch attachment is constructed of steel.

7) The trailer hitch attachment of claim 1, further comprising a bucket of a front end loader.
